(19) United States
(12) Patent Application Publication
(10) Pub. No.: US 2026/0071893 A1
(43) Pub. Date: Mar. 12, 2026

(54) Utility Monitoring Device

(71) Applicants: James Shea, New Iberia, LA (US); Charles Shea, Aledo, TX (US)

(72) Inventors: James Shea, New Iberia, LA (US); Charles Shea, Aledo, TX (US)

(21) Appl. No.: 19/074,548

(22) Filed: Mar. 10, 2025

Related U.S. Application Data
(60) Provisional application No. 63/692,338, filed on Sep. 9, 2024.

(51) Int. Cl. G01D 4/00

(52) U.S. Cl. CPC G01D 4/004; G01D 4/008

(57) ABSTRACT

A utility monitoring application device is disclosed, which is a software and/or mobile application for monitoring all home and business utilities (i.e., gas, electric, water, etc.) on one site. The utility monitoring application device includes a wall display sensor which is tied to each utility at the entrance of the home or business to monitor usage and leaks and transmit the information wirelessly to the software application. The user will input his or her normal monthly usage of electricity, gas, and water into the unit or application. If the user exceeds the normal monthly usage, he/she will be notified through the application or sensors. The device will prevent overuse and overcharging. Further, monthly reminders can be sent for bills. Users may also monitor the application for potential leaks.

### CROSS-REFERENCE TO RELATED APPLICATION

The present application claims priority to, and the benefit of, U.S. Provisional Application No. 63/692,338, which was filed on Sep. 9, 2024, and is incorporated herein by reference in its entirety.

### FIELD OF THE INVENTION

The present invention relates generally to the field of utility monitoring application devices. More specifically, the present invention relates to a monitoring system for utilities, allowing users to view usage and bills in a single location. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in utility monitoring application devices. Generally, keeping track of utility usage in homes and businesses can be difficult. People may be unaware of a running toilet, lights that are left on, or gas leaks from a stove or other gas lines. Further, excessive usage of electricity or gas can lead to expensive monthly utility bills. Monitoring for specific utilities may be available through a website or software application, however, each utility (i.e., electric, gas, etc.) may require an individual website or application login.

Furthermore, modern society is dependent on the use of utility resources (e.g., electricity, water, natural gas, air, and other industrial gases and fluids) to operate devices and systems in residential, commercial, and industrial environments. As the cost of owning or operating a home or a business is dependent on the use cost of utility resource usage, most users of utility resources desire to receive information regarding their consumption of such utility resources. Conventionally, users are provided with information regarding their consumption of utility resources on a monthly basis and with little detail. As such, it is difficult for users to understand whether they are utilizing utility resources in an efficient manner or how their usage of utility resources may be improved. This leads to waste and unnecessary expense.

Accordingly, there is a demand for an improved utility monitoring application device that provides users with a monitoring system for utilities, allowing users to view usage in a single location. More particularly, there is a demand for a utility monitoring application device that saves time and effort for anyone monitoring several utilities throughout the month.

Therefore, there exists a long-felt need in the art for a utility monitoring application device that provides users with a monitoring system for utilities, such as gas, electric, and water. There is also a long-felt need in the art for a utility monitoring application device that allows users to view usage and bills in a single location. Further, there is a long-felt need in the art for a utility monitoring application device that eliminates the need for separate website logins or mobile applications to view individual utility information. Moreover, there is a long-felt need in the art for a device that features a wall display sensor that can identify usage of a utility near its meter and transmit that information wirelessly to the software application. Further, there is a long-felt need in the art for a utility monitoring application device that includes multiple notifications that can help prevent over usage, leaks, and forgetting to pay a bill. Finally, there is a long-felt need in the art for a utility monitoring application device that saves time and effort for anyone monitoring several utilities throughout the month.

The subject matter disclosed and claimed herein, in one embodiment thereof, comprises a utility monitoring application device. The device is a software and/or mobile application for monitoring all home and business utilities (i.e., gas, electric, water, etc.) on one site. The utility monitoring application device includes a wall display sensor which is tied to each utility at the entrance of the home or business to monitor usage and leaks and transmit the information wirelessly to the software application. The user will input his or her normal monthly usage of electricity, gas, and water into the unit or application. If the user exceeds the normal monthly usage, he/she will be notified through the application or sensors. The device will prevent overuse and overcharging. Further, monthly reminders can be sent for bills. Users may also monitor the application for potential leaks.

In this manner, the utility monitoring application device of the present invention accomplishes all of the foregoing objectives and provides users with a device that monitors all home and business utilities. The device is a software application that monitors usage and transmits information to users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a utility monitoring application device. The device is a software and/or mobile application for monitoring all home and business utilities (i.e., gas, electric, water, etc.) on one site. The utility monitoring application device includes a wall display sensor which is tied to each utility and which transmits the information wirelessly to the software application. Further, if the user exceeds predetermined thresholds, notifications are sent to prevent overuse and overcharging.

In one embodiment, the utility monitoring application device collects, processes, and reports utility usage information at one or more facilities associated with a user(s). The utility monitoring application device is advantageously adapted to integrate a wide variety of different utility meters to provide a user with a comprehensive and detailed understanding of utility resource usage by the user all in one location on their smart devices. The utility resource(s) can include water, air, gas, electricity, steam, and/or other industrial fluids or gases, which are consumed and/or utilized by one or more devices at the user site(s).

Typically, a plurality of utility meters are provided at the user site(s) to monitor the utility resource(s) separately. As used herein, the term “utility meter” is defined to be any device that is configured to monitor at least one utility resource. The utility meters can include smart meters, non-smart meters, pulse-output meters, adapters, combinations thereof, and/or the like. The utility meters can be of a variety of different models and types from one or more manufacturers.

In one embodiment, the utility monitoring application device utilizes a smartphone, a tablet, a laptop, a desktop computer, etc., or any other suitable electronic device that has the required operating and memory parameters to support the software application of the present invention.

In one embodiment, the utility monitoring application device utilizes a mobile computing device (i.e., smartphone, computer, tablet, etc.) comprising a software application which is a monitoring app designed to monitor and manage a user's utilities. The mobile or software application provides a secure website and/or smartphone app access by users for monitoring utilities and sending any necessary alerts. In addition to these elements, the device of the present invention may also include a web server and Cloud database of location and utility data connectable to the mobile smartphone or portable tablet or computer device.

In one embodiment of the invention, the utility data and data management software are maintained on a Microsoft Cloud server in a typical fashion, or other cloud server, such as the Adobe, Apple, or Amazon cloud server, etc. A secure cloud server is used for the protection and security of the utility data, and other needed information data stored on the cloud server for the other utility services. Thus, the utility data is sent to the cloud server and collected. Conveniently, the data is stored and managed with a data management software or program to manage the collected utility data.

Typically, a cellular wireless data network embedded in the computer, tablet or smartphone, etc., transmits utility data at requested times to a user. Such utility data can be processed by a Cloud data management server.

In one embodiment, a wall display sensor is utilized in identifying usage of a utility based on data from its meter. The wall display sensor is mounted on a wall near the utility meter and transmits the information wirelessly to the software application. Typically, a wall display sensor is mounted and tied to (in communication with) each utility meter at the entrance of the home or business or wherever the meter is located. Once the information is collected, it is periodically sent to the software application. Generally, the utility information is sent wirelessly to the software application, which then allows a user to access the information via the application interface. Once accessed, the user can set up alerts depending on the data collected, such that the user can be notified of overuse, overcharges, leaks, and/or bill reminders, etc.

In one embodiment, the user manually inputs his or her normal monthly usage of electricity, gas, and water into the wall display sensors and/or directly in the software application. Then, the sensors collect additional utility data and send this data wirelessly to the software application. Accordingly, if the user exceeds the normal monthly usage, he/she will be notified through the application or sensors. Thus, the utility monitor application device will essentially prevent overuse and overcharging. Further, monthly reminders can be sent for bills and other needs. Users may also monitor the software application for potential leaks and set up any suitable reminders or alerts they deem necessary.

In yet another embodiment, the utility monitoring application device comprises a plurality of indicia.

In yet another embodiment, a method of monitoring utilities using a software application is disclosed. The method includes the steps of providing a utility monitoring application device comprising a software application that monitors and provides information on utility usage to users. The method also comprises utilizing sensors to gather and monitor information from utilities. Further, the method comprises wirelessly transmitting the information to the software application. Finally, the method comprises accessing the software application to view usage and report potential leaks.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the utility monitoring application device of the present invention showing the interface of the software application in accordance with the disclosed architecture;

FIG. 2 illustrates a perspective view of one embodiment of the utility monitoring application device of the present invention showing the gas and water utilities in communication with the sensor in accordance with the disclosed architecture;

FIG. 3 illustrates a perspective view of one embodiment of the utility monitoring application device of the present invention showing the electric utility in communication with the sensor in accordance with the disclosed architecture;

FIG. 4 illustrates a flowchart showing the method of monitoring utilities using a software application in accordance with the disclosed architecture;

FIG. 5 is a schematic diagram illustrating one embodiment of the utility monitoring application device of the present invention in accordance with the disclosed architecture; and

FIG. 6 illustrates an exemplary user device that is used for installing the utility monitoring application device of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a utility monitoring application device that provides users with a monitoring system for utilities, such as gas, electric, and water. There is also a long-felt need in the art for a utility monitoring application device that allows users to view usage and bills in a single location. Further, there is a long-felt need in the art for a utility monitoring application device that eliminates the need for separate website logins or mobile applications to view individual utility information. Moreover, there is a long-felt need in the art for a device that features a wall display sensor that can identify usage of a utility near its meter and transmit that information wirelessly to the software application. Further, there is a long-felt need in the art for a utility monitoring application device that includes multiple notifications that can help prevent over usage, leaks, and forgetting to pay a bill. Finally, there is a long-felt need in the art for a utility monitoring application device that saves time and effort for anyone monitoring several utilities throughout the month.

The present invention, in one exemplary embodiment, is a novel utility monitoring application device. The device is a software and/or mobile application for monitoring all home and business utilities (i.e., gas, electric, water, etc.) on one site. The utility monitoring application device includes a wall display sensor which is tied to each utility at the entrance of the home or business to monitor usage and leaks and transmit the information wirelessly to the software application. The user will input his or her normal monthly usage of electricity, gas, and water into the unit or application. If the user exceeds the normal monthly usage, he/she will be notified through the application or sensors. The device will prevent overuse and overcharging. The utility monitoring application device can also average the monthly usage input of the utility and break it down to daily usage. This will allow the device to monitor on a daily basis with alerts, if needed. Further, monthly reminders can be sent for bills. Users may also monitor the application for potential leaks. The present invention also includes a novel method of monitoring utilities using a software application. The method includes the steps of providing a utility monitoring application device comprising a software application that monitors and provides information on utility usage to users. The method also comprises utilizing sensors to gather and monitor information from utilities. Further, the method comprises wirelessly transmitting the information to the software application. Finally, the method comprises accessing the software application to view usage and report potential leaks.

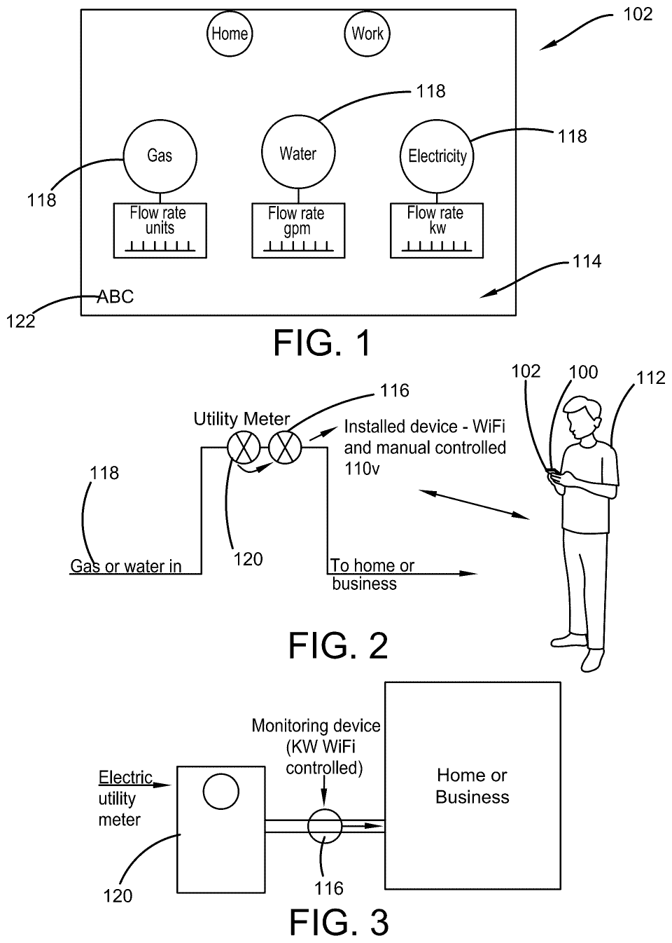

Referring initially to the drawings, FIG. 1 illustrates a perspective view of one embodiment of the utility monitoring application device 100 of the present invention. In the present embodiment, the utility monitoring application device 100 is a software application that monitors all home and business utilities 118 (i.e., gas, electric, water, etc.) on one site. Specifically, the utility monitoring application device 100 is a unique software application accessible on a smartphone 102, tablet, laptop, or a desktop computer (i.e., user device 102). Users 112 utilize an interface 114 to monitor utility usage and potential leaks. The utility monitoring application device 100 includes a wall display sensor 116 which is tied to each utility meter 120 and which transmits the information wirelessly to the software application. Further, if the user 112 exceeds predetermined thresholds, notifications are sent to prevent overuse and overcharging.

Generally, the utility monitoring application device 100 collects, processes, and reports utility usage information at one or more facilities associated with a user(s) 112. The utility monitoring application device 100 is advantageously adapted to integrate a wide variety of different utility meters 120 to provide a user 112 with a comprehensive and detailed understanding of utility resource usage by the user 112 all in one location on their smart devices 102. The utility 118 resource(s) can include water, air, gas, electricity, steam, and/or other industrial fluids or gases, which are consumed and/or utilized by one or more devices 100 at the user site(s).

Typically, a plurality of utility meters 120 are provided at the user site(s) to monitor the utility 118 resource(s) separately. As used herein, the term “utility meter” 120 is defined to be any device that is configured to monitor at least one utility resource 118. The utility meters 120 can include smart meters, non-smart meters, pulse-output meters, adapters, combinations thereof, and/or the like. The utility meters 120 can be of a variety of different models and types from one or more manufacturers.

Further, the utility monitoring application device 100 utilizes a smartphone 102, a tablet, a laptop or a desktop computer, etc., or any other suitable electronic device that has the required operating and memory parameters to support the software application of the present invention.

Additionally, the utility monitoring application device 100 utilizes a mobile computing device 102 (i.e., smartphone, computer, tablet, etc.) comprising a software application which is a monitoring app designed to monitor and manage a user's utilities. The mobile or software application provides a secure website and/or smartphone app access by users 112 for monitoring utilities 118 and sending any necessary alerts. In addition to these elements, the device 100 of the present invention may also include a web server and Cloud database of location and utility data connectable to the mobile smartphone 102 or portable tablet or computer device.

Furthermore, the utility data and data management software are maintained on a Microsoft Cloud server in a typical fashion, or other cloud server, such as the Adobe, Apple, or Amazon cloud server, etc. A secure cloud server is used for the protection and security of the utility data, and other needed information data stored on the cloud server for the other utilities services. Thus, the utility data is sent to the cloud server and collected. Conveniently, the data is stored and managed with a data management software or program to manage the collected utility data.

Typically, a cellular wireless data network 106 embedded in the computer, tablet or smartphone 102, etc., transmits utility data at requested times to a user 112. Such utility data can be processed by a Cloud data management server.

As shown in FIGS. 2-3, a wall display sensor 116 is utilized in identifying usage of a utility 118 based on data from its meter 120. The wall display sensor 116 is mounted on a wall near the utility meter 120 and transmits the information wirelessly to the software application. Typically, a wall display sensor 116 is mounted and tied to (in communication with) each utility meter 120 at the entrance of the home or business or wherever the meter 120 is located. Once the information is collected, it is periodically sent to the software application. Generally, the utility information is sent wirelessly to the software application, which then allows a user 112 to access the information via the application interface 114. Once accessed, the user 112 can set up alerts depending on the data collected, such that the user 112 can be notified of overuse, overcharges, leaks, and/or bill reminders, etc.

Further, the user 112 manually inputs his or her normal monthly usage of electricity, gas, and water into the wall display sensors 116 and/or directly in the software application. Then, the sensors 116 collect additional utility data and send this data wirelessly to the software application. Accordingly, if the user 112 exceeds the normal monthly usage, he/she will be notified through the application or sensors 116. Thus, the utility monitor application device 100 will essentially prevent overuse and overcharging. Further, monthly reminders can be sent for bills and other needs. Users 112 may also monitor the software application for potential leaks and set up any suitable reminders or alerts they deem necessary.

In yet another embodiment, the utility monitoring application device 100 comprises a plurality of indicia 122. The smart device 102 of the device 100 may include advertising, a trademark, or other letters, designs, or characters, printed, painted, stamped, or integrated into the smart device 102, or any other indicia 122 as is known in the art. Specifically, any suitable indicia 122 as is known in the art can be included, such as, but not limited to, patterns, logos, emblems, images, symbols, designs, letters, words, characters, animals, advertisements, brands, etc., that may or may not be utility, monitoring, or brand related.

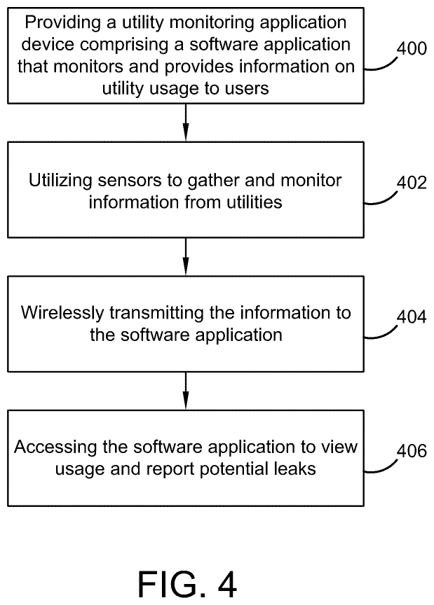

FIG. 4 illustrates a flowchart of the method of monitoring utilities using a software application. The method includes the steps of at 400, providing a utility monitoring application device comprising a software application that monitors and provides information on utility usage to users. The method also comprises at 402, utilizing sensors to gather and monitor information from utilities. Further, the method comprises at 404, wirelessly transmitting the information to the software application. Finally, the method comprises at 406, accessing the software application to view usage and report potential leaks.

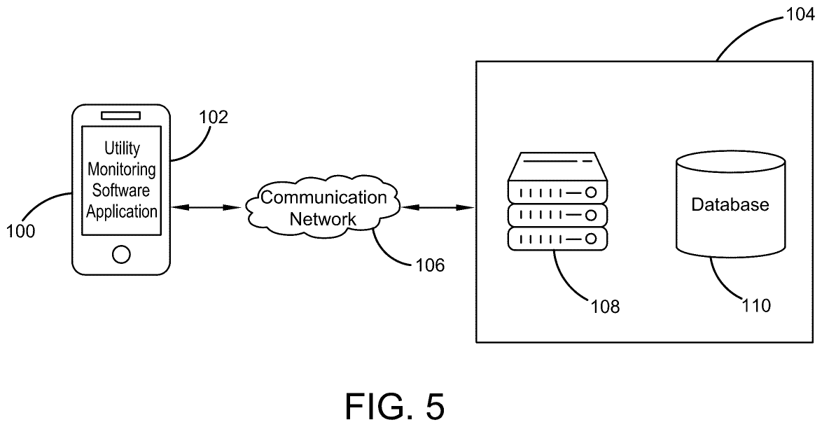

FIG. 5 is a schematic diagram illustrating one embodiment of the utility monitoring software application 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smartphone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a .NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the application 100, as well as utility information and predetermined thresholds. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address), and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

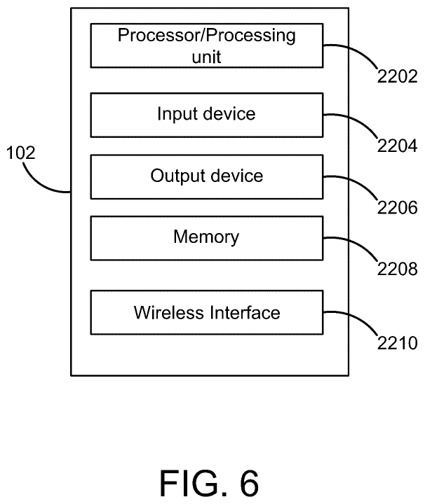

FIG. 6 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot, and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “utility monitoring application device”, “utility monitoring device”, “application device”, and “device” are interchangeable and refer to the utility monitoring application device 100 of the present invention.

Notwithstanding the foregoing, the utility monitoring application device 100 of the present invention can be of any suitable size and configuration as is known in the art without affecting the overall concept of the invention, provided that it accomplishes the above-stated objectives. One of ordinary skill in the art will appreciate that the utility monitoring application device 100 as shown in FIGS. 1-6 is for illustrative purposes only, and that many other sizes and shapes of the utility monitoring application device 100 are well within the scope of the present disclosure. Although the dimensions of the utility monitoring application device 100 are important design parameters for user convenience, the utility monitoring application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A utility monitoring application device that monitors all home and business utilities on one site, the utility monitoring application device comprising:
a software application; and
a wall display sensor;
wherein the software application is accessible on a smart device;
wherein the wall display sensor monitors at least one utility meter; and
further wherein the wall display sensor sends utility data to the software application.

2. The utility monitoring application device of claim 1, wherein the smart device is a smartphone, tablet, laptop, or a desktop computer.

3. The utility monitoring application device of claim 2, wherein the utility meter is an electric, gas, or water meter.

4. The utility monitoring application device of claim 3, wherein the utility meter includes smart meters, non-smart meters, pulse-output meters, adapters, or combinations thereof.

5. The utility monitoring application device of claim 4, wherein the software application provides a secure website or smartphone app access by users for monitoring utility data from at least one utility meter.

6. The utility monitoring application device of claim 5 further comprising a web server and Cloud database of utility data connectable to the smart device.

7. The utility monitoring application device of claim 6, wherein a cellular wireless data network embedded in the smart device transmits utility data at requested times to a user.

8. The utility monitoring application device of claim 7, wherein the wall display sensor is mounted on a wall near the at least one utility meter.

9. The utility monitoring application device of claim 8, wherein the wall display sensor is in communication with the at least one utility meter.

10. The utility monitoring application device of claim 9, wherein the wall display sensor transmits information wirelessly to the software application.

11. The utility monitoring application device of claim 10, wherein once the information is accessed by a user, a user can utilize the software application to set up alerts and be notified of overuse, overcharges, or leaks.

12. The utility monitoring application device of claim 11, wherein a user can manually input monthly usage data of electricity, gas, and water into the wall display sensor or directly in the software application.

13. A utility monitoring application device that monitors all home and business utilities on one site, the utility monitoring application device comprising:
a software application accessible on a smart device; and
a wall display sensor mounted on a wall near at least one utility meter and in communication with the at least one utility meter;
wherein the software application provides a secure website or smartphone app access by users for monitoring utility data from at least one utility meter;
wherein a cellular wireless data network embedded in the smart device transmits utility data at requested times to a user;
wherein the wall display sensor monitors the at least one utility meter;
wherein the wall display sensor transmits information wirelessly to the software application; and
further wherein once the information is accessed by a user, a user can utilize the software application to set up alerts and be notified of overuse, overcharges, or leaks.

14. The utility monitoring application device of claim 13 further comprising a plurality of indicia.

15. The utility monitoring application device of claim 13, wherein if the user exceeds a predetermined normal monthly usage, the user will be notified through the software application or through the wall display sensor.

16. The utility monitoring application device of claim 15, wherein monthly reminders can be sent for bills.

17. The utility monitoring application device of claim 13, wherein the smart device is a smartphone, tablet, laptop, or a desktop computer.

18. The utility monitoring application device of claim 13, wherein the utility meter is an electric, gas, or water meter.

19. The utility monitoring application device of claim 11, wherein a user can manually input monthly usage data of electricity, gas, and water into the wall display sensor or directly in the software application.

20. A method of monitoring utilities using a software application, the method comprising the following steps:
providing a utility monitoring application device comprising a software application that monitors and provides information on utility usage to users;
utilizing sensors to gather and monitor information from utilities;
wirelessly transmitting the information to the software application; and
accessing the software application to view usage and report potential leaks.
